(19) United States
(12) Patent Application Publication
(10) Pub. No.: US 2016/0330588 A1
(43) Pub. Date: Nov. 10, 2016

(54) Location-based services and related information systems using a virtual beacon device

(71) Applicant: Wonchan LEE, Seoul (KR)

(72) Inventor: Wonchan LEE, Seoul (KR)

(21) Appl. No.: 14/813,497

(22) Filed: Jul. 30, 2015

(30) Foreign Application Priority Data
May 4, 2015 (KR) 10-2015-0062807

(51) Int. Cl. H04W 4/02; H04W 16/28

(52) U.S. Cl. CPC H04W 4/025; H04W 16/28

(57) ABSTRACT

The invention relates to a location-based services and related information systems using a virtual beacon device comprising Virtual Beacon Architecture Diagram1 is when the base station receives a frequency signal of 100 Number by a view of the structure of a virtual beacon 101 separated from the signal of one unit and the Pico cell selection to the base station signal of the smallest unit of 102 to give it a specific Identity and it gives a number sequence in it. And the assigned sequence number is converted to a Cell of Location sector as a minimum unit on the physical space. The transformed cell is converted to a single Cell of map 103. This will divide the map of the physical space in the form of a Cell on a minimum unit. Cell thus the divided minimum unit is the display position of the virtual beacons on each of the Flag value by ON/OFF type. That is, ON is 1 is OFF will be zero.

### TECHNOLOGY AREAS

The present invention is an invention by the method and the virtual beacon system related information and location-based services via the link information of the other system using the virtual beacons of the functions of the hardware type and write the interaction based on the information and communication technology Bluetooth 4.0 The invention of the configuration, various information system services.

To the beacon first need a virtualization technology for each frequency is usually (ω), or expressed in radians per second (in radians/second), f−Hertz (Hz) also indicates. It can also indicate a BPM (beats per minute) and RPM (revolutions per minute). Each frequency ω (rad/sec) and f (Hz) of the relationship is shown in the following formula: ω=2πf. Frequency is also the phase (φ) The relevant transitional, and also the offset of the waveform specific point at the initial time (t0), even (degrees) or represents in radians. Looking at the example of a sine wave, the waveform function is. (Amplitude: A, angular frequency: ω, phase: (φ). The present invention can use a variety of services and the characteristics of these frequency characteristics and the band and the base station carrier frequency and the frequency wifi network services using the same frequency network all internet and so on. The frequency of the beacon frequency on a location-based map the frequency to be used by utilizing the properties, regardless of the bandwidth pre-coated with the frequency hopping scheme of the beacon frequency to the original frequency with the frequency of the other mask in the area of the main characteristics modulation in a manner such as by using the physical characteristics of the frequency of the beacon is a technique to provide a virtual device in a manner of receiving a beacon frequency.

And the use of these virtual beacon devices in conjunction with the linkage information, location-based services system, the invention relates to a method for the various services.

### BACKGROUND TECHNOLOGY

Described in which the background of the invention rather than use the Bluetooth frequency by radio frequency ISM band of 2.4 GHz band is placed in the Bluetooth can be used worldwide. However, each slightly different from country to country, but most of the countries of America and Europe are working using a frequency band of 83.5 MHz using a 79-channel, each with a space of 1 MHz. However, Japan, Spain and France have been using with a space of less than 23 channels, each 1 MHz. Japan is assigned, but so far as the Bluetooth frequency 23 MHz, 10 May, 1999 Japanese MPT in the same manner as the United States

It agreed to extend a 2400˜2483.5 MHz announced.

The Bluetooth protocol, the frequency is divided into a portion of the HID and RFCOMM, which defines the interface between the base defining the like RF, band hopping pattern that specifies the physical layer, link manager, to define the configuration of the packet, L2CAP and the above host system. In addition, the configuration from the top of the baseband frame, error control, authentication (Authentication), encryption (Encryption) and the like are defined here. Voice CODEC is adopted CSVD and log PCM of 64 kbps. And the protocol stack of TCP/IP is mounted on the top of L2CAP. As the interface with the host USB, EIA-232, it is mounted.

In the mobile communication using a multiple access technique in order to accommodate a large number of users to one frequency band. However, even if using a multiple access when a certain amount or more users access the channel at the same time up saturation normal service is difficult.

In the mobile communication base station is located in the middle of the cell small cell divides a large area in order to better use the limited frequency resources by using a particular frequency, and provides a service by service and recycling back to the same frequency at more than a certain distance away from the base station It can enhance the frequency use efficiency.

Usually four types of frequencies are used for a mobile communication service.

The adjacent cells are using different frequency away while avoiding the problems caused by interference can be seen that the cell recycling the same frequency.

With this configuration the cell can serve a large area with a limited number of frequencies. The maximum traffic that cannot afford a cell is constant. Cell can be thought of as having the same intensity and wavelength electron becomes a circle around the base station on a plane.

Actually a polygon shape according to the adjustment of the field intensity of the compartment and the adjacent cells.

By reducing the radius of the cell area it is reduced to half to one-fourth.

Therefore, to reduce the size of the cells in half in the same area and a cell four Number, the acceptable traffic also increased by four Number.

This traffic is usually much of the cell is reduced in size by a small call volumes change is cell size can be increased by properly arranged.

Size kinds of cells used real mega cell (Mega Cell): Satellite communications widely used in cell radius 100 cells of 500 km, macro cells (Macro Cell): a small radius cell suburbs mobile subscribers within 35 Km, microcell (Micro Cell): 0.5 km—distance of about the cell the mobile antenna with a radius of 1 km with a view to the eye is the main propagation path. Is the radius of the cell diversity effect is small, propagation occurs in that the receiving antenna via different paths.

Pico cells (Pico Cell): The arrangement of the cells within a 50 m radius of the city center and underground areas.

One of the cell can be divided into sectors than three minutes. One called an directional cell the case of service to all the cells via the antenna, and by dividing the particular region into a plurality of directional antennas in the sector cell when the service is called for.

Currently, most of the cell is designed for cell-directional call quality and capacity of the cell increases.

And will be described in the Bluetooth frequency above modulation frequency of the Bluetooth uses a method called a transmission GFSK Rate 1 Mbps.

FSK modulation on the modulation scheme used by the modulator based on the front-end filter has a Gaussian characteristic.

Power consumption is 30 μA in normal mode, when sending the aims to be limited to 8˜30 mA.

In addition, the Bluetooth which is a type of spread spectrum system to reduce the interference with other devices

Use a frequency hopping method. This method is to change the frequency every Random 1 Time Slot

That operates to prevent interference by the transmission frequency of the fixing. In the case of Bluetooth 1

Time Slot frequency hopping occurs 1600 Number per second to 625 μs.

Basically, a unit to the first hopping slot (625 μs= 1/1600 second) TDD (Time Division Duplex) To be sent and received from. The throughput of data transmission in a single direction up to 721 kbps/asymmetric.

In the data sent and received Master and Slave always use the even-numbered slot is always an odd slot

It will use the Lot.

Slots can be reserved for packet synchronization. Each packet is transmitted in a different hop frequency.

Packet is normally cover a slot, but can be extended to cover up to five slots.

Bluetooth is one of asynchronous data channels, and at the same time can support up to three voice channels,

Or with a synchronous voice it can support an asynchronous data at the same time. Each audio channel of 64 Kbps East

Supports-term (voice) link. Asynchronous channel in the reverse direction and up to 721 Kbps in one direction

Allowing a 56.7 Kbps can support an asymmetric link, or if a symmetric link to 432.6 Kbps You may want. It can utilize the characteristics of the more mobile communication base stations of Bluetooth technology and frequency of the beacon frequency to create a virtual device and establish a location-aware service information associated with the system.

### PRIOR ART DOCUMENT

### Patent Literature

None

### Non-Patent Document

None

### [The Contents of Invention]

### To Solve Problems

The invention utilizes a frequency of the base station and the virtual area and virtual beacon matching the virtual area the real area by specifying the area and that the real space region in the virtual space area giving the coordinates of the virtual beacons in the virtual space of the virtual beacon service In the phase of the signal frequency generated by the built virtual beacon frame and re-process the beacon to improve the accuracy and performance of the virtual location also make it to the server, the server receiving information about the signal of the beacon analysis and re-processing through an in conjunction with other information to the server system for providing it and make the task of providing an application service to users and administrators to create a method for building different types of location-based information system to solve the problem of the present invention. A component is to place the Access Point of a virtual beacon for each information Point, receiving the ID of the virtual beacon signal provides the location and the user information linked to a different server from the server, receiving the information that the information systems each feature subjected to the logic of the information system for the present invention and it is to flow to make the flow of information to an existing virtual beacon system again.

### Solving Means of the Problem

Solving means of the present invention using a variety of services with respect to the frequency characteristics of the frequency band characteristics using any network using the wifi network, the base station carrier frequency and the frequency and the Internet network, such as installing a virtual beacon frequency and using a virtual beacon information and that the system e m for the purpose of service. All the frequencies used by utilizing the characteristics of the frequency used for communication on the location-based map pre virtual beacon frequency band, regardless of the mask in the area of the other existing virtual beacon frequency to the frequency with the frequency of the basic properties a modulation and demodulation method of frequency hopping in such a way by the physical properties of the clad as a technology for providing a virtual frequency of the beacon reception device in a manner that a virtual beacon frequencies by utilizing a virtual beacon device location based service associated with the information system the work-up method of the present invention according to a variety of services.

The present invention is a virtual space with a virtual beacon only is installed with an area with which it build service as the existing system with a virtual beacon information and other information by utilizing the system and logic particular way using the frequency of the Bluetooth communication concepts link described for technologies that make up the various virtual beacon-based location-based information to the system through the features of the present invention.

### Effects of the Invention

The invention that is referred to as one person beacon beacon services through a specific hardware of the known signal, the indoor location based services and information services through a variety of service, without specific hardware beacon (beacon devices) of the beacon device and a virtual presence in a particular location it It can be obtained using a technique that can provide a variety of location-based services and information services. That is, the type that can hold the beacon information services system which provided the information service system, the service is based on the hardware by setting a virtual beacon, and also recognizes it and the reference point. By using this virtual beacon and installed manually by creating a beacon device to be a lot of space or does stop with no hardware costs and maintenance such as battery exchange, if the only place to reach any existing communications frequencies where various indoor locations You can configure specific services and information services. In other words, this is not provided with detailed information the physical constraints of the existing space in the daily life and the user or an object is physically located, especially for people that can not be inserted into the access space, mainly the camera or other device, or other but there should be obtaining information about the position sensor or experience the present invention there is any person in the place where that is not able to reach the area on radio waves or frequencies can take advantage of the internal position information and the location information service there, that it is the largest feature of the invention.

### DESCRIPTION OF THE DRAWINGS

FIG. 1 Virtual Beacon Architecture

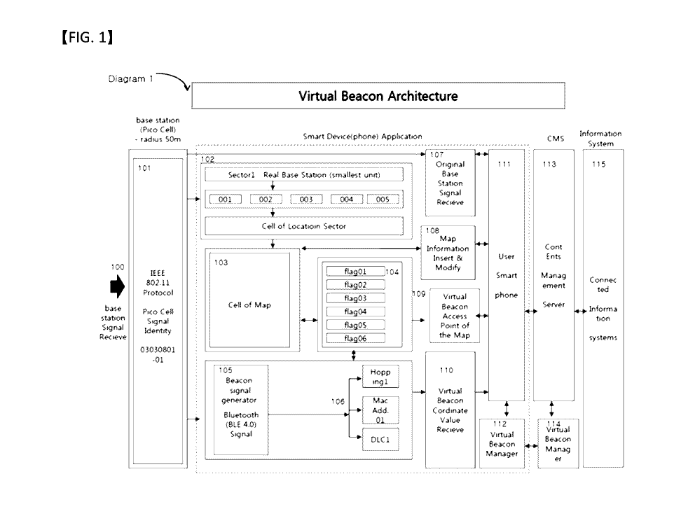

FIG. 2 Base Station Signal

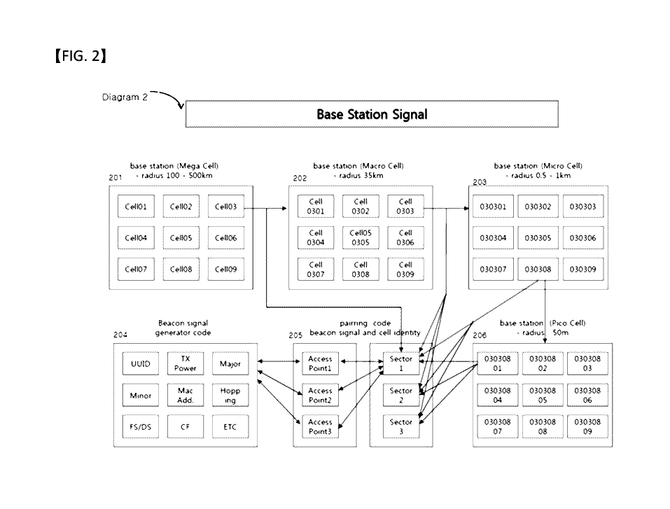

FIG. 3 Base Station pico Cell

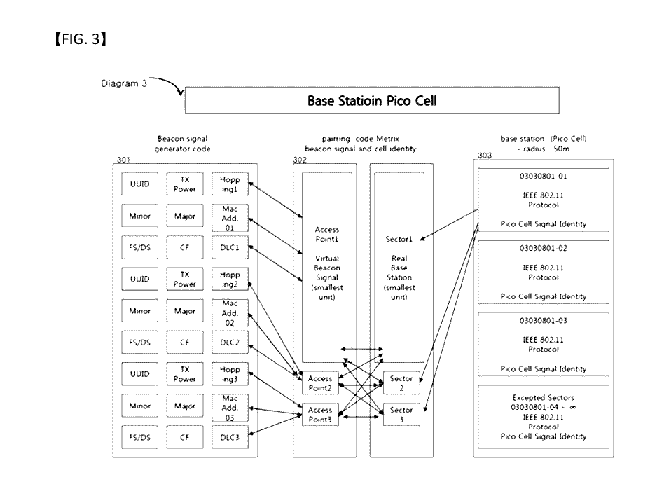

FIG. 4 Pairing Code Matrix

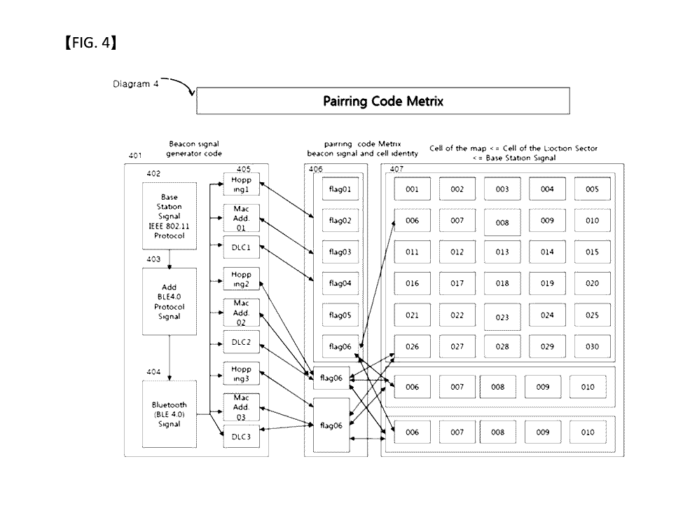

FIG. 5 Beacon Signal Generator

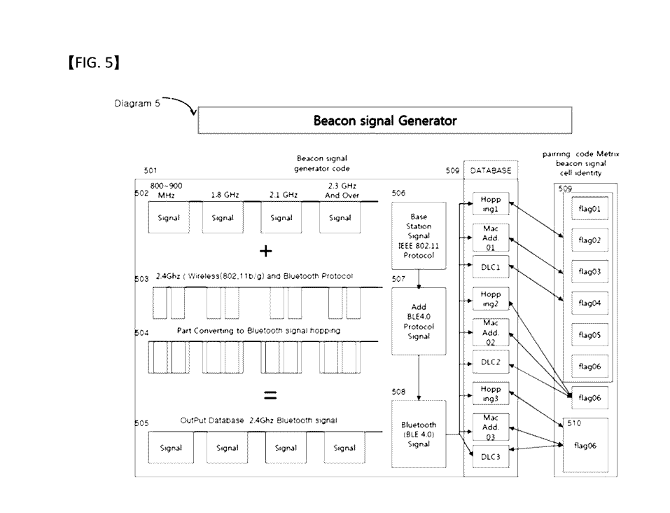

FIG. 6 Cell of the map and Coordinate Value

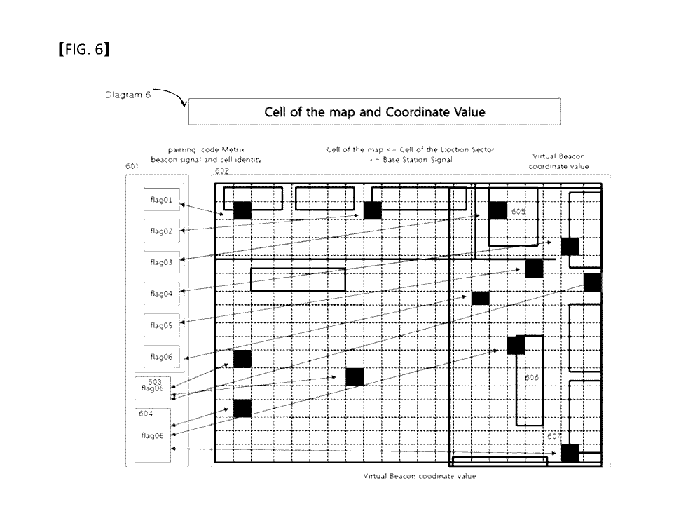

FIG. 7 Bluetooth Frame DLC(Device Location Code)

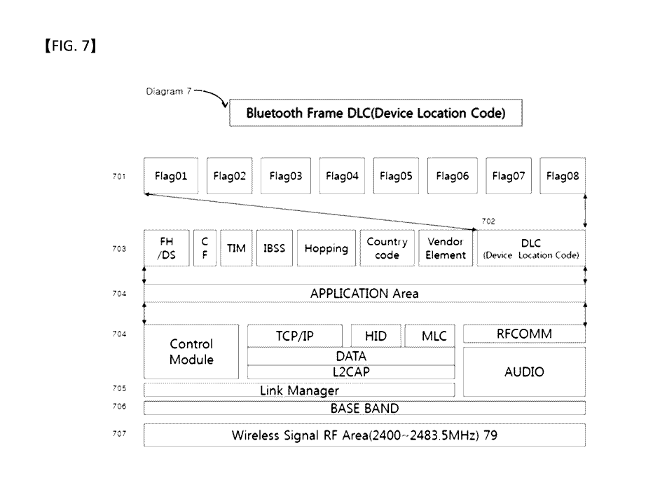

FIG. 8 Virtual Beacon Process

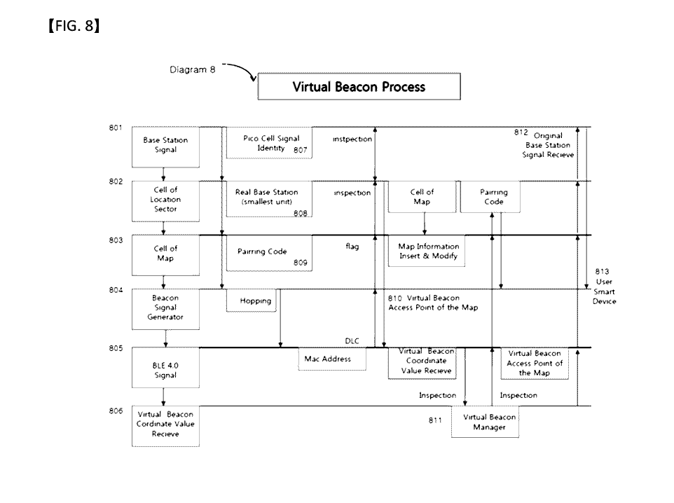

FIG. 9 All information System on based Virtual Beacon

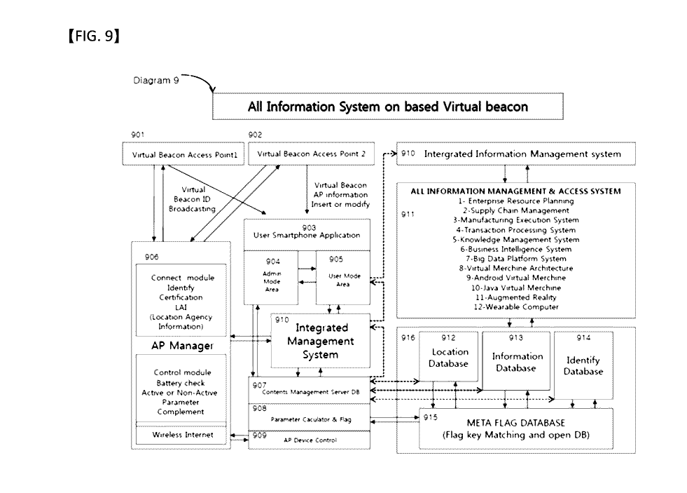

### DETAILED DESCRIPTION OF CARRYING OUT THE INVENTION

The present invention is an invention by the method and the virtual beacon system related information and location-based services via the link information of the other system using the virtual beacons of the functions of the hardware type and write the interaction based on the information and communication technology Bluetooth 4.0 configuration, various information service system of the invention by a Bluetooth wireless communication protocol frame via the re-extraction process based on the position of various information, and a processing them through a server system and associated with other information to the user terminal or the smart devices for through the invention, including the associated system to the user unique, unique location-based information systems and other information systems that service.

In more detail to the Diagram for example

Virtual Beacon Architecture Diagram1 is when the base station receives a frequency signal of 100 Number by a view of the structure of a virtual beacon 101 separated from the signal of one unit and the Pico cell selection to the base station signal of the smallest unit of 102 to give it a specific Identity and it gives a number sequence in it. And the assigned sequence number is converted to a Cell of Location sector as a minimum unit on the physical space. The transformed cell is converted to a single Cell of map 103. This will divide the map of the physical space in the form of a Cell on a minimum unit. Cell thus the divided minimum unit is the display position of the virtual beacons on each of the Flag value by ON/OFF type. That is, ON is 1 is OFF will be zero. That is separated by the minimum unit for Cell physical space and virtual beacon is positioned to be the Cell flag value is 1, an area for that virtual beacons are not present is by no flag value is 0 to the virtual space and the position location beacon is that the space is separated there. That is, flag generating the position of the virtual beacons in a virtual space by a value, modified, deleted and is used when the flag value is always 103. 104 single cell of map one 109 and one virtual beacon Access point of map association with user mode through the It can be controlled from an application.

Also, 104 single flag values 105 Number over Beacon Signal generator for generating a beacon signal and that are also linked beacon signals coming out of the software itself create value, which is over 106 Number by hopping key values, such as the Mac Address and DLC (Device Location Code) is the main value, UUID, Major, Minor, Txpower, Rssi values output from the beacon of the general hardware type is also outputted together. One beacon signal generator 105 virtual beacon signals 110 Number Virtual Beacon Coordinate Value that is generated from, and receive indications from the App on your smart phone device to a virtual beacon coordinates, Pico Cell Signal received over 101 Number in 107 As technology Original Base Station Signal as received by one communication frequency is used for communication, if, when used in other applications as other purposes. At 108 Number the Map information insert & Modify application areas show the form that enables users to create and modify one of the 103 Cell of Map. That is, the basic form of the user and the actual Cell of map or be modified to show that the type of Map-specific random. This generally utilize a frequency of the base station (communication, academic, research) that is received in the area of the minimum unit that also divided to create the form of the Cell Map to number based upon the number given to it there through the Flag value defines the position of a virtual beacon, and that through the virtual beacon signal generated by the frequency and Pairing virtual beacon signal generator The Code is generated and let it in 108 Number, 109 Number, 111 Number your smart phone application area 110. After a single application processing area. The 112 is certain modify the application area as a Virtual Beacon manager that controls the virtual beacons values for the virtual beacon signal is generated by generating a virtual (UUID, Major, Minor, Txpower, Rssi etc.) and parasitic It will serve to perform an operation to monitor whether or status of a virtual beacon Cell.

Referring back to the core content of the present invention where the first is based on the frequency of the base station is received by the smart devices create a virtual space with a virtual beacon, and the beacon only the room service and a location based service information providing service to the virtual installation The can also be a beacon to which a hardware manager to position in a particular place and create a virtual space with a virtual beacons in the area and the interior, and location-based service and information service provided by the virtual installation as described in this Diagram1 that beacon service has wish list That is, the virtual beacons can be maintained by generating the beacon through two way path.

So PUSH generated virtual beacon is viewed as a beacon of virtual information over 113 Number CMS (Contents Management Server) is based on 111 single user application area and the beacon information of explicitly to re-register as a user application, or let one 114 Virtual Beacon Manager Administration stop by each virtual beacon device, 115 single contact information system (CRM, SCM, AMS, KMS, etc.) can provide a service and variety of information associated with the system via the system manager through the real and virtual beacon of the beacon manager through.

Diagram2 is a diagram of how to distribute the base station as a signal to receive Cell Base Station Signal and how it matched with the beacon signal. 201 Number that shows the range of mega-cell type of the base station denotes a base station signal to the radius range in the range 100˜500 km, 35 km range of 202 Number shows a Cell signal range to the base station of the macro cell. 203 Number in a range of micro-cell base station signal indicates the range of the base station signal 0.5 KM˜1 km range. 206 Pico Cell and one has a signal range that matches the typical signal range of the base station hardware as a beacon signal range of the radius of 50 M. It is generally defined by Pico Cell may define as the most suitable one single 202 macro cell and microcell 203 Number Sector Units also a virtual beacon signal area to define the range of the signal using its territory as a Sector.

Sector area 205 Number that dividing been defined as the combined making Pairing Code which defines lowered by being combined with the ID value of the Beacon signal to each cell. That is, 201 Number, 202 Number, 203 Number, Identity value of 206 Number each Cell (03,0303,0308,03030801) and AP values are obtained from the values of the virtual beacons of the virtual space with a virtual single information of the beacon signal 204 Pairing It generates a Code.

Diagram3 Base Station Pico Cell is a pico cell base station unit and how the virtual beacon drawing showing how to connect a single virtual beacon signal generator 301 via which Hopping Key value creation and equipment of unique Mac Address and DLC (Device Location Code) Specifies the value of the Access Point Virtual Beacon Signal as over 302 Number the value. This value will generate a specified AP Pairing Code as a virtual base station signal range Cell and matrix structure of the actual minimum unit of the Sector is formed to mate. With this description back to the pair formed which means that the area of the actual BS to a specific frequency and an area match with each other and for the virtual beacons. In other words if the virtual area and thus on the actual frequency of the region are matched to the location of the beacon specified in the virtual area through a virtual beacon information that would be thereby matched with the value of the flag values shown in the Cell Sector.

Diagram4 Pairing Code Matrix is a virtual space and how the virtual space and real space diagram explaining in detail how to make up a matrix pair Diagram3 as described in the preceding pairs matrix code of the actual space.

401 single Beacon Signal generator Code is combined single Bluetooth Signal 403 based on the incoming signal from the base station 402 in the basic primary communication protocol illustrates a beacon signal generator 404 generates a single unique common beacon signals and the beacon signal 405 Number the value through it It shows that to produce. Hopping key value of the beacon signal is generated from the virtual beacon signal generator indicates a characteristic that distinguishes the type of modulation and the Key value of the virtual beacon signal with a demodulation algorithm for the virtual beacons, Mac Address is the hardware on the network for the virtual beacon It is given a unique value that indicates the character. DLC is also indicates whether the virtual beacons in a virtual space as the characterizing serves the location of the device on the network located anywhere. This value means that they create a matching key through the physical space and one flag value 406 is divided by the Cell Identity value so given through the frequency of the actual base station. This match will be a key value Pairing Code. That is, Hopping Key Cell base station by dividing the value of the actual signals that govern the Identity assigned to the virtual space and the virtual space of the beacons, Mac Address, and the actual value match each other through the DLC virtual beacon is generated by the virtual space on a real space that located in the space which is displayed by the Flag value up to the real beacon to recognize as a specific place in the actual space.

flag value 407 is a single number is given in the Identity and Cell of the map matching of a particular cell, if any virtual beacon flag value is 1, and if it does not exist that has a value of 0.

Diagram5 Beacon Signal Generator is the structure of the virtual beacon signal generator from 501 Number to 502 Number the figure indicated by the various base stations (depending on national frequency management policy broadcasting, mobile communications, research, military, satellite, etc.) to signal received from a base station for applying a bluetooth protocol, and 503 Number the frequency of the demodulation and modulation in a manner produce a bluetooth signal frequency as 505 Number. So it has created is a virtual beacon signal Hopping Key to the values and Mac Address and DLC as a major value as 509 Number the value stored in each Field in the Database. Virtual beacon signal are thus stored to specify the Access Point to the Cell Identity Flag values and actual values of the area of the receiving frequency range from the real base station.

FIG. 504 where the base station frequency and the single common frequency derived by the Bluetooth protocol, the frequency of the demodulation and modulation in a manner as the modulation algorithm is constant m=Vm/Vc=(V max−V min) to give/(V max+V min), communication signals constant Vc (t)=VcCOS (2πfct+θ) and fi (t)=1/2π*dθi (t)/dt=a modulation scheme when the fc to Default is 2fc=2Vc (t)=2 (Vm/Vc)=m, and the demodulation scheme is configured such that fc=Vc (t)=Vm/Vc=2 m is. Generating a demodulation frequency through the modulation of the frequency is the properties as Bluetooth frequency by applying a Hopping scheme. By applying the method in the form of a Hopping Hoping key value is defined, this can be used also as a Key value remove the original base station signal with a frequency in a virtual beacon Key values that define the characteristics of the beacon signal generated as a virtual beacon signal There. In other words, the frequency of the base station based on the frequency signal based on the demodulation and modulation of the virtual beacon is going through the encryption process with Hopping Key value If this value does not get back to the original Hopping Key base station frequency type.

Hopping Key values can be used to take advantage of modifying the virtual beacons in the interval necessary cryptographic security, it can be also used to encrypt the data frequency. Diagram6 the Cell of the map and Coordinate Value Parsing the scope of the actual areas from the space station and frequency as cell coordinates in the virtual space through the map matching information in real space with virtual beacons and areas designated by the flag value is set It shows a shape characterizing the position of the virtual beacons in the coordinate values in the map for.

601 single pairing code matrix is to position a virtual beacon for a real space, which matches the virtual space by matching the coordinate value of the actual regions of mainly the value of the virtual storage and virtual beacon flag value set through the information 0 or 1. Cell of the map that is displayed so Cell of the location sector of the beacon that is, the virtual position in the real area been specified from the base station signal frequency is specified. This particular virtual beacon has the same phase as the actual hardware installed in the real beacon region, it will be in the form of receiving the beacon signals from the user's Email application.

Installing the Virtual Beacon is indicated by the black dots of the actual hardware Diagram6 beacon in the area of physical location, but when you accept your smart phone built on the virtual dotted line in a specific area in a specific area indicated by the dotted line in the diagram been real and virtual areas It is shown as been.

Diagram7 is common to represent Bluetooth Frame DLC frame Bluetooth device location code 703 as a protocol structure of a general view for explaining the detailed functionality of a DLC of the beacon signal generated by the beacon signal generator 105 Number in a typical beacon signal Diagram1 Virtual Beacon Architecture through this area in addition the DLC region separately from the beacon signal frame builds its own specific position in the virtual space of the beacon device. 701 has a value, moves, the time value of the beacon signal generating step as a flag value, the flag value that is different from the concept of the present invention Pairing code matrix. A combination of a location-related constant DLC value for the virtual beacons in the virtual space in accordance with 1 or 0, depending on whether or not a place still moving place or without 1 or 0, depending on the location range of 1 or 0 whether or not change, changes to the location coordinates fried tofu according to 1 or 0, depending on the existing 1 or 0 whether or not the current time change, time change according to the scope 1 and the presence of 0, the error range Over 1 or 0, which is given to 1 or 0 in accordance with a security code applied according to the presence or absence The DLC value is sent to the CMS server, the CMS server to the DLC Calculator operation with reference to the DLC-value converting current values to the position of the virtual beacon. This information is the current state of the virtual beacon, distance, location, movement value, time, error tolerance, and which performs a conversion to a value.

Diagram8 will Virtual Beacon Process is a view for explaining the processing of the virtual beacon by base station signal 801 Number the received application program and recognize the 802 single physical space in Cell of Location Sector constructions a single 803 Cell of map. Here is given a single 807 Pico Cell Identity signal to each unit, and divide the real space unit Cell type of at least However, this

Hopping Key 804 based on the single value from the beacon signal and the lyric flag value generated by it over the virtual beacon signal generator to generate the identity of each Cell in Pairing Code. User through the Map information insert & Modify area in parallel, where you can enter the information directly to the Cell of map or modify it may improve the accuracy and reliability of the Map. Since the first to reach the original base station signal is received over the Original base station Signal 812, will be used as a smart phone communication base station side frequency communication, if there are other uses to fit through the user smart devices of the original frequency of the base station service You can receive at the same time in parallel.

That is, the so generated based on the received base station beacon frequency 805 Number the frequency virtual area through a virtual particular constructed 801,802,803,804 described above, the virtual beacons, virtual beacon locations on the map calculated by the real frequency domain, and the virtual beacons ARE will generate a continuous virtual beacon frequency as 805 Number, 806 Number over been converted into a virtual area real space areas, the Virtual Beacon Coordinate Value to be received by the virtual 0.811 Number will display the virtual beacon manager such as the presence or absence of a particular state or activate a virtual beacon was built on a specific region of the cell becomes a virtual beacon control manager. That is where Virtual Beacon Access point of the map, there's a virtual beacon location on a virtual map area you can control via the virtual beacon managers, and also can replace the virtual manager as a beacon of tangible hardware devices. In other words, use the virtual space and real space and virtual beacon control manager can also be configured as a virtual beacon but as existing in the virtual space and a virtual beacon exists by installing only one beacon device manager to control the virtual space in a real beacon.

Beacon manager if the real hardware so you can communicate directly with the Internet, the CMS to perform the role of a specific region and activated virtual and virtual beacon, drawing credibility and accuracy of data on actual space than a virtual beacon capable of creating and modifying user there is an advantage that could be in effect immediately.

Diagram9 shows a description of all the information associated with the information system All Information System on based Virtual Beacon virtual beacons in the Diagram.

The actual space as 901 Number and 902 Number in virtual space by there specific locations and virtual beacon device coordinates that define the Virtual Beacon Access Point with virtual beacon so defined shall continue Broadcasting the Virtual Beacon ID periodically. So that broadcasting frequencies are linked with one integrated management system 910 through 904 Administrator Mode 905 single-user mode from single-user applications, however, Flag 909 Number and 908 Number Parameter Calculator are linked via the AP Device Control and values.

Connect Module 906 via a beacon device via the virtual communication by the manager to display the beacon in both two kinds of hardware or software to set the position of a virtual beacon, check the logical level of the battery and the active and inactive virtual beacons and each beacon control It performs control for the parameter values. 901 Number, 909 Number, until the virtual beacon system from a variety of information, as described this as a representation of the structure to 911 Number through work with an integrated information technology system to 910 Number the basic system and virtual beacon server with a CMS 908 Number how to configure a variety of information systems can be applied to the virtual beacons that work of Flag Parameter Calculator and the value of 915 Number META Flag Data base.

Location Database 912 Number, 916 Number and 913 Number and 914 Number Identify Database Information Database is a database of other linked information exchange system that works with virtual beacon service area, 907 Number the database of the virtual beacon services through this and work with one 908 Parameter and Flag have a structure.

Virtual beacon as described above is generally the base station is received (frequency-operating state according to the broadcast policy, the mobile communication, research, military, satellite, etc. Any bands) by using a frequency domain by considering an actual physical area of the virtual, In addition, the generic beacon service for real space domain by creating a virtual space with a virtual beacon signal to match the two setting a virtual beacon for a particular point in the region that matches the virtual and real and virtual beacon signal received by it, to create an integrated information system through the virtual connection with location-based services and other services, and other information service system is the core of the present invention.

That is, the present invention as described above is not the information system and methodology based on a simple virtual beacon converting real space based on the virtual beacons in the virtual space and position the virtual devices of the beacon again in the virtual space by using it By default, for the invention in conjunction with information systems of the various information systems Virtual beacon-based customer management system, Virtual beacon-based disaster evacuation systems, virtual beacon-based access control system, based virtual beacon Asset management system, based virtual beacon advertising platform for linking the virtual link information system based on the method invention is expanded when the cloud that is based on the type of equipment or space constraints of the physical no, only additional existing basic information system The actual hardware that all the infrastructure without any connection with the invention that by existing information systems in the form of a virtual object as the Internet cloud is completely built in the form of virtual objects and virtual Internet information merging system without adding a new hardware device The invention can be seen the actual information system effective is the important feature of the present invention.

### Example

The actual application must implement to apps or PC software for smart phones

### INDUSTRIAL APPLICABILITY

With both the smart phone and tablet PC in the general network and can also be used with existing information systems linked

### REFERENCE NUMERALS

Virtual Beacon=Cyber Beacon=Virtual Beacon Device

### ACCESSION NO.

If you want to organize separately listed on the accession number of microbes that are listed in the description

### SEQUENCE LISTING FREE TEXT

Repeat as necessary to base the free text appearing in the Sequence Listing attached to the specification

1. A location-based services and related information systems using a virtual beacon device comprising Virtual Beacon Architecture Diagram1 is when the base station receives a frequency signal of 100 Number by a view of the structure of a virtual beacon 101 separated from the signal of one unit and the Pico cell selection to the base station signal of the smallest unit of 102 to give it a specific Identity and it gives a number sequence in it.

2. A location-based services and related information systems using a virtual beacon device comprising Diagram2 is a diagram of how to distribute the base station as a signal to receive Cell Base Station Signal and how it matched with the beacon signal.

3. A location-based services and related information systems using a virtual beacon device comprising Diagram3 Base Station Pico Cell is a pico cell base station unit and how the virtual beacon drawing showing how to connect a single virtual beacon signal generator 301 via which Hopping Key value creation and equipment of unique Mac Address and DLC (Device Location Code) Specifies the value of the Access Point Virtual Beacon Signal as over 302 Number the value.

4. The location-based services and related information systems using a virtual beacon device according to claim 1, further comprising: Diagram4 Pairing Code Matrix is a virtual space and how the virtual space and real space diagram explaining in detail how to make up a matrix pair Diagram3 as described in the preceding pairs matrix code of the actual space.

5. The location-based services and related information systems using a virtual beacon device according to claim 1, further comprising: Diagram5 Beacon Signal Generator is the structure of the virtual beacon signal generator from 501 Number to 502 Number the figure indicated by the various base stations (depending on national frequency management policy broadcasting, mobile communications, research, military, satellite, etc.) to signal received from a base station for applying a bluetooth protocol, and 503 Number the frequency of the demodulation and modulation in a manner produce a bluetooth signal frequency as 505 Number.

6. The location-based services and related information systems using a virtual beacon device according to claim 2, further comprising: Diagram6 the Cell of the map and Coordinate Value Parsing the scope of the actual areas from the space station and frequency as cell coordinates in the virtual space through the map matching information in real space with virtual beacons and areas designated by the flag value is set It shows a shape characterizing the position of the virtual beacons in the coordinate values in the map for.

7. The location-based services and related information systems using a virtual beacon device according to claim 2, further comprising: Diagram7 is common to represent Bluetooth Frame DLC frame Bluetooth device location code 703 as a protocol structure of a general view for explaining the detailed functionality of a DLC of the beacon signal generated by the beacon signal generator 105 Number in a typical beacon signal Diagram1 Virtual Beacon Architecture through this area in addition the DLC region separately from the beacon signal frame builds its own specific position in the virtual space of the beacon device.

8. The location-based services and related information systems using a virtual beacon device according to claim 3, further comprising: Diagram8 will Virtual Beacon Process is a view for explaining the processing of the virtual beacon by base station signal 801 Number the received application program and recognize the 802 single physical space in Cell of Location Sector constructions a single 803 Cell of map.

9. The location-based services and related information systems using a virtual beacon device according to claim 3, further comprising: Diagram9 shows a description of all the information associated with the information system All Information System on based Virtual Beacon virtual beacons in the Diagram.
